(19) United States
(12) Patent Application Publication
(10) Pub. No.: US 2015/0082107 A1
(43) Pub. Date: Mar. 19, 2015

(54) STATE MACHINE BASED FUNCTIONAL STRESS TESTS

(71) Applicant: Jicksen JOY, Sunnyvale, CA (US)

(72) Inventor: Jicksen JOY, Sunnyvale, CA (US)

(21) Appl. No.: 14/172,887

(22) Filed: Feb. 4, 2014

Related U.S. Application Data
(60) Provisional application No. 61/880,167, filed on Sep. 19, 2013.

(51) Int. Cl. G06F 11/26

(52) U.S. Cl. CPC G06F 11/26
USPC 714/724

(57) ABSTRACT

According to one general aspect, a method of testing an integrated circuit may include executing, on a system control processor of the integrated circuit, a Silicon Test Environment (STE). The STE may be configured to facilitate an interaction of a functional test program with a processor without aid of an operating system. The method may include executing, on a processor of the integrated circuit, one or more instances of the STE. The method may include establishing a plurality of functional test programs by instructing each of the one or more instances of the STE to each perform a respective functional test program targeting a respective hardware component of the integrated circuit. The method may include collecting data produced by the execution of the functional test programs.

### CROSS-REFERENCE TO RELATED APPLICATION

This application claims priority under 35 U.S.C. §119 to Provisional Patent Application Ser. No. 61/880,167, entitled “STATE MACHINE BASED FUNCTIONAL STRESS TESTS” filed on Sep. 19, 2013. The subject matter of this earlier filed application is hereby incorporated by reference

### TECHNICAL FIELD

This description relates to the testing of electrical circuits, and more specifically to the functional testing of complex electrical circuits, such as, processors, system-on-a-chip, etc.

### BACKGROUND

Traditionally, electronic circuits are subjected to testing at many stages of design and production. Often this testing includes functional testing. A functional test is typically performed in the last phase of the production of a product, and may be considered a form quality control. Generally, functional tests are performed to ensure that the device under test (DUT) fulfills its functional specifications. Generally, instead of using test-points to perform the functional test, customer specific connectors (e.g., pins of the integrated circuit) are used to perform the functional test.

Often test software is used that allows testing operators to perform the functional test in an automatic way through a computer. To do this, the software frequently communicates with external programmable instruments (e.g., input/output (I/O) boards, communication ports, etc.). The software, in conjunction with the test fixture that interfaces the instruments with the DUT, makes it possible to perform a number of functional tests.

Generally, when the DUT includes a microprocessor or a system-on-a-chip (SOC) the test software includes an operating system (OS), such as, Windows, Linux, Android, etc. In general, an OS is a collection of software that manages computer hardware resources and provides common services for computer programs. In general, an OS sits between the testing software and the DUT. This means that the testing software is subject to the vagaries of the OS and the OS's management of the interactions between the testing software and the DUT hardware.

### SUMMARY

According to one general aspect, a method of testing an integrated circuit may include executing, on a system control processor of the integrated circuit, a Silicon Test Environment (STE). The STE may be configured to facilitate an interaction of a functional test program with a processor without aid of an operating system. The method may include executing, on a processor of the integrated circuit, one or more instances of the STE. The method may include establishing a plurality of functional test programs by instructing each of the one or more instances of the STE to each perform a respective functional test program targeting a respective hardware component of the integrated circuit. The method may include collecting data produced by the execution of the functional test programs.

According to another general aspect, an apparatus may include a system control processor, a processor, and one or more hardware components. The system control processor may be configured to execute a Silicon Test Environment (STE). The STE may be configured to facilitate an interaction of a functional test program with a processor without an aid of an operating system. The processor may be configured to execute one or more instances of the STE, and execute, via the one or more instances of the STE, a plurality of functional test programs, wherein each functional test program is configured to target a respective hardware component. The one or more hardware components configured to be tested by the plurality of functional test programs.

According to another general aspect, a computer program product may be tangibly and non-transitorily embodied on a computer-readable medium. The computer program product may include executable code that, when executed, is configured to cause an apparatus to execute, via a system control processor of the apparatus, a Silicon Test Environment (STE). The STE is configured to facilitate an interaction of a functional test program with a processor without an aid of an operating system. The computer program product may include executable code that, when executed, is configured to cause an apparatus to execute, via a processor of the apparatus, one or more instances of the STE. The computer program product may include executable code that, when executed, is configured to cause an apparatus to establish a plurality of functional test programs by instructing each of the one or more instances of the STE to each perform a respective functional test program targeting a respective hardware component of the apparatus. The computer program product may include executable code that, when executed, is configured to cause an apparatus to collect data produced by the execution of the functional test programs.

The details of one or more implementations are set forth in the accompanying drawings and the description below. Other features will be apparent from the description and drawings, and from the claims.

A system and/or method for transmitting data or information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a flowchart of an example embodiment of a technique in accordance with the disclosed subject matter.

FIG. 3 is a flowchart of an example embodiment of a technique in accordance with the disclosed subject matter.

FIG. 4 is a schematic block diagram of an information processing system, which may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

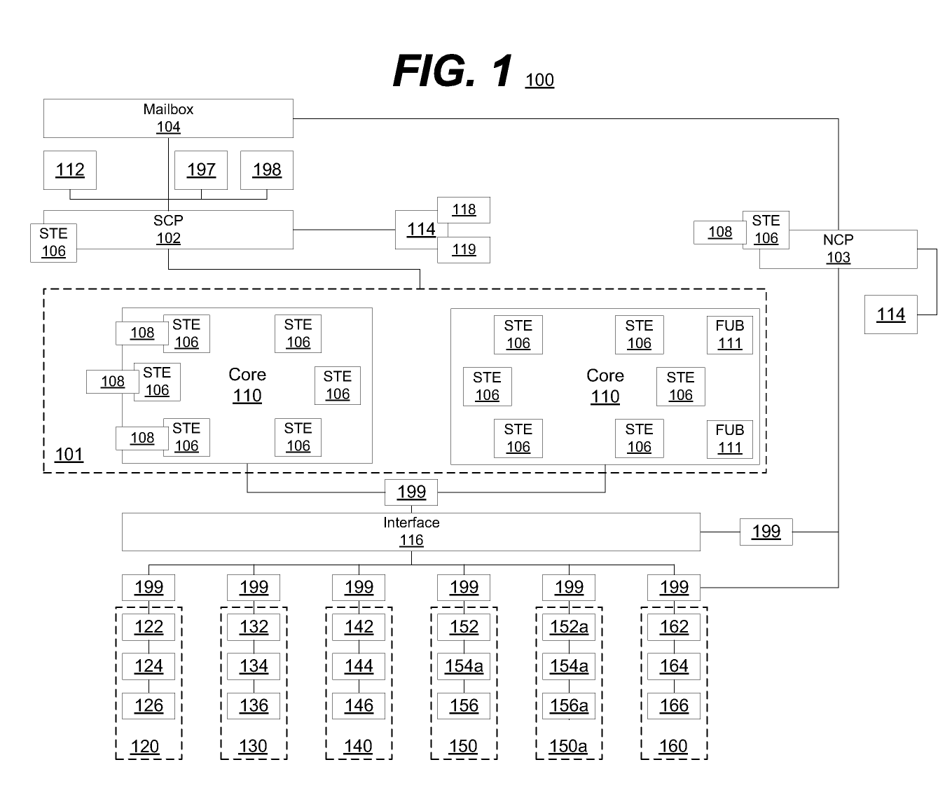

FIG. 1 is a block diagram of an example embodiment of a system in accordance with the disclosed subject matter. In the illustrated embodiment, the system 100 may include a processor, a system-on-a-chip (SoC) or other integrated circuit. It is understood that the above is merely one illustrative example to which the disclosed subject matter is not limited.

In various embodiments, the system-on-a-chip (SoC) 100 may include a system control processor (SCP) 102. In various embodiments, the SCP 102 may include a specialized processor included within the SoC 100. In such an embodiment, the SCP 102 may be configured to interface between the rest of the SoC 100 and the SCP 102. In one such embodiment, other portions of the SOC 100 may report messages and/or parameters to the SCP 102 via a mailbox 104, counters 197, and/or timers 198. Based upon these messages the SCP 102 may alter the operating parameters or settings of various portions of the SOC 100. For example, the SCP 102 may cause a piece of software, firmware, or combination therefore to be executed by the multi-core processor 101, or the network control processor (NCP) 103. In another example the SCP 102 may alter the frequency, bandwidth, word size, etc. of one or more network buses or communication interfaces (e.g., the universal serial bus (USB), Ethernet, etc.). It is understood that the above are merely a few illustrative examples to which the disclosed subject matter is not limited.

In one embodiment, a test engineer or user (not shown) may cause a silicon test environment (STE) 106 to be executed by the SCP 102. In the illustrated embodiment, the STE 106 may include a series of instructions configured to, when executed, facilitate the interaction of a functional test program 108 with a processor 101 or processor core 110 without aid of an operating system. As described above, a modern OS is a heavy piece of software that is large enough to consume significant system resources (e.g., memory, computing cycles, etc.) just to execute itself. This means that the test programs 108 are not able to test the hardware directly but must work through the OS and as a result test only a version of the hardware that is under an indeterminate amount of load (the load caused by the OS itself). Conversely, the STE 106 may be thought of as a micro or light-weight OS that is configured to consume a minimum of system resources and allows the test programs 108 direct or near direct access to the tested hardware (e.g., core 110, USB, Ethernet, etc.) without the interference caused by a normal or typical OS. In some embodiments, the STE 106 may be thought of as being closer to a Basic Input/Output System (BIOS) than a traditional OS.

In the illustrated embodiment, the STE 106 may also differ from an OS (and a normal BIOS) in that multiple instances of the STE 106 may be executed substantially simultaneously by a processor (e.g., the processor 101, a particular core 110, the SCP 102, the NCP 103, etc.). In various embodiments, this may occur without the use of a virtual machine or virtualization engine (as would be needed to execute multiple instances of a traditional OS). In such an embodiment, the instances of the STE 106 may operate substantially independently, as described below. In another embodiment, the STE 106 may coordinate or at least read and/or write to common or shared variables (e.g., an execution flag, an error flag, a results file, etc.).

In one embodiment, the user may interact with the SCP 102 via a communications port 112. In some embodiments, the communicator's port 112 may include a Universal Asynchronous Receiver/Transmitter (UART) port, Joint Test Action Group (JTAG) port, Inter-Integrated Circuit (IIC or I2C) bus, Serial Peripheral Interface (SPI) bus, or similar interface. It is understood that the above are merely a few illustrative examples to which the disclosed subject matter is not limited.

In various embodiments, the SCP 102 may be in communication with or make use of a memory 114. In some embodiments, the memory 114 may be configured to store one or more pieces of data, either temporarily, permanently, semi-permanently, or a combination thereof. Further, the memory 114 may include volatile memory, non-volatile memory or a combination thereof. In various embodiments, the STE 106 may be stored, in whole or part, in the memory 114. In various embodiments, the memory 114 may be shared, in whole or part between the SCP 102, the NCP 103, and the processor 101. In another embodiment, various components of the SoC 100 may include or be associated with their respective separate memories (not explicitly illustrated).

As described above, the user may place an instance of the STE 106 on the SCP 102 (e.g., via the communications port 112). In such an embodiment, this may allow the user to communicate with the rest of the SoC 100.

In various embodiments, the SoC 100 may include a multi-core processor 101. In such an embodiment, the processor 101 may include a plurality of cores 110 (of which two are illustrated). In some embodiments, these cores 110 may include general-purpose microprocessor cores, each configured to execute a series of instructions included by a computer program. In various embodiments, a core 110 may include one or more sub-units or sets of combinatorial logic blocks (CLBs), or functional unit blocks (FUBs) 111. In various embodiments, these FUBs 111 may include groups of logic such as, an instruction fetch unit (IFU), an arithmetic logic unit (ALU), a floating-point unit (FPU), a level-1 (L1) cache, etc. It is understood that the above are merely a few illustrative examples to which the disclosed subject matter is not limited.

In various embodiments, once the user is in communication with the SCP 102 and by extension the rest (or most) of the SOC 100, the user may place a plurality of instances of the STE 106 or a modified versions thereof, on the cores 110. In the illustrated embodiment, each core 110 is configured to execute six instances of the STE 106, for a total of 12 instances of the STEs 106 executing on the processor 101. In another embodiment, each core 110 may be configured to execute 10 instances of the STE 106. In yet another embodiment, each core 110 may be configured to execute only one instance of the STE 106. It is understood that the above are merely a few illustrative examples to which the disclosed subject matter is not limited.

In one embodiment, once the one or more instances of the STE 106 are being executed by the processor 101, one or more functional test programs 108 may be established or configured. In such an embodiment, establishing the test programs 108 may include configuring the respective instances of the STEs 106 to execute or manage the execution of the one or more respective test programs 108. In some embodiments, this may be done via the SCP 102. In various embodiments, the test program 108 may include a series of instructions that cause the processor 101 or other device to perform a series of operations directed towards a tested piece of hardware. In some embodiments, the test program 108 may include comparing an actual result against an expected result, and determining the correctness of the actual result. In another embodiment, the test program 108 may include merely collecting data. It is understood that the above are merely a few illustrative examples to which the disclosed subject matter is not limited.

In various embodiments, each test program 108 may be configured to target one or more hardware components included by the SoC 100. In some embodiments, a test program 108 may be configured to target a low-level hardware component. In one embodiment, a test program 108 may be configured to target an atomic function of a desired hardware component. In the illustrated embodiment, this may be a feature of the STE 106, as opposed to a modern OS. In such an embodiment, the STE 106 may be configured to facilitate the interaction of the test program 108 with the hardware component and more specifically the exact features of the hardware component without interference.

In one embodiment, the SoC 100 may include a plurality of busses or hardware components that are external to the processor 101. In the illustrated embodiment, some of these hardware components may be in communication with the processor 101 via a bus. In such an embodiment, these hardware components may be targeted for testing. In such an embodiment, a test program 108 may be configured to exercise or cause the hardware component to perform one or more functions under a certain set of parameters or settings.

For example, in various embodiments, the SoC 100 may include a Serial Advanced Technology Attachment (SATA) bus 120 that includes a computer bus interface configured to connect host bus adapters to one or more mass storage devices such as hard disk drives and optical drives. In such an embodiment, the SATA bus 120 may include a SATA controller 122, a SATA physical layer component (PHY) 124, and a SATA device 126. In the illustrated embodiment, the SATA bus 120 may communicate with the processor 101 via an interface 116.

In one embodiment, a test program 108 may be configured to perform functional testing of the SATA bus 120 or a portion thereof. In such an embodiment, the test program 108 or the STE 106 may be configured to cause the SATA bus 120 to operate under a predetermined set of parameters (e.g., 1.5 gigabits (Gbit)/second, 3 Gbit/second, 150 Megabytes (MB)/second, 600 MB/s, etc.). In various embodiments and depending upon the hardware component being tested, these parameters may include, but are not limited to, an operational frequency, a bandwidth, a width of a bus, an error correction setting, an electrical voltage, etc.

In one embodiment, a test program 108 may be configured to cause the hardware component (e.g., the SATA bus 120, etc.) to perform one or more operations (e.g., read data from the SATA device 126, etc.). In various embodiments, the test program 108 may target a specific operation or function of a sub-component of the hardware device. For example, the test program 108 may be configured to test or cause the SATA PHY 124 to perform link initialization under the predetermined set of parameters. It is understood that the above is merely one illustrative example to which the disclosed subject matter is not limited.

As described above, in various embodiments, the STE 106 may be configured to allow the test program 108 to access or dictate to the hardware component (e.g., the SATA PHY 124, etc.) the instructions or electrical signals needed to perform or initiate the desired tested function (e.g., start link initialization, etc.). This may differ from a typical OS, in which the test program 108 would only be able to request that the OS perform more high-level or abstracted functions and would not be able to access specific functions of a hardware component.

In various embodiments, the SoC 100 may also include a Peripheral Component Interconnect Express (PCIe) bus 130, a USB 140, a network interface (e.g., Ethernet 170), one or more memory channels, etc. In some embodiments, the PCIe bus 130 may include a PCIe root complex (RC) 132, PCIe-PHY 134, and PCI endpoint (EP) 136. In various embodiments, the USB140 may include a USB controller 142, a USB-PHY 144, and a USB device 146. In one embodiment, the Ethernet bus 170 may include a 10 Gb Ethernet (10 GbE) may include a 10 GBE media access control (XGMAC) Controller 172, a 10 GbE Attachment Unit Interface (XAUI) PHY 174, and a 10 Gb device port 176. In various embodiments, the memory may include a double data rate (DDR) memory bus that may include two channels 150 and 150a, each channel may include a DDR controller 152 & 152a, a DDR PHY 154 & 154a, and a DDR dynamic random access memory (DRAM) 156 & 156a. It is understood that the above are merely a few illustrative examples to which the disclosed subject matter is not limited.

In various embodiments, one or more test programs 108 may be configured to target or test various aspects of the hardware components 120, 130, 140, etc. In the illustrated embodiment, with 12 test programs 108 being executed substantially simultaneously by the 12 STEs 106 of the cores 110 (although FIG. 1 only shows three due to illustrative limitations), up to six aspects of the hardware components of the SOC 100 may be tested substantially simultaneously. This may speed up the overall testing of the SOC 100 considerably. As described above, with a typical OS such simultaneous testing may not have been possible as the OS is configured to regulate interaction between the processor 101 and the hardware components. Therefore, the timing of the instructions issued by the test programs 108 are at the mercy of the OS. It is understood that the above is merely one illustrative example to which the disclosed subject matter is not limited.

Moreover, in various embodiments, the test programs 108 may be configured to target different hardware components using different parameter sets. For example, in the case of the two memory channels 150 and 150a, a first test program 108 may configure the first memory channel 150 to operate under a first set of parameters (e.g., type 3 synchronization, latencies of 8-8-8, a memory clock of 200 MHz, etc.). In such an embodiment, a second test program 108 may configure the second memory channel 150a to operate under a second set of parameters (e.g., type 3 synchronization, latencies of 7-7-7, a memory clock of ˜133 MHz, etc.). In such an embodiment, the variety of sets of parameters may be tested more quickly by testing two or more sets in parallel than what could be done by testing the sets of parameters in a series fashion. It is understood that the above is merely one illustrative example to which the disclosed subject matter is not limited.

In various embodiments, some test programs 108 may be configured to test or target different sub-portions of a hardware component. For example, a first set of test programs (e.g., a first test program and a second test program) may be configured to target a first hardware component. Specifically, in one embodiment, the first test program 108 may target the PCIe-RC 132, and the second test program 108 may target the PCIe PHY 134. Likewise, a second set of test programs (e.g., a third test program and a fourth test program) may be configured to target a second hardware component. Specifically, in one embodiment, the third test program 108 may target the USB controller 142, and the fourth test program 108 may target the USB PHY 144. It is understood that the above are merely a few illustrative examples to which the disclosed subject matter is not limited.

In various embodiments, the test programs 108 may also be configured to test portions of the core 110 (e.g., FUBs 111, etc.) or other hardware components of the SoC 100. For example, in some embodiments, one or more of the test programs 108 may target or test the NCP 103, the mailbox 104, the SCP 102, etc. or other hardware components not illustrated. It is understood that the above are merely a few illustrative examples to which the disclosed subject matter is not limited.

In various embodiments, the user may establish a plurality of test programs 108 on the various STEs 106 in a sequential or serial fashion. In such an embodiment, the execution of the test programs 108 may be halted or delayed based upon a flag variable 118. In such an embodiment, the STEs 106 or test programs 108 may periodically check the flag variable 118 to determine if it is a predetermined value (e.g., a Boolean true, etc.). In such an embodiment, until the flag variable 118 is equal to the predetermined value the execution of the test programs 108 may be halted or paused. Once the flag variable 118 is equal to the predetermined value, all of the test programs 108 may start their execution. In various embodiments, a plurality of flag variables 118 may be used or employed. In some embodiments, some test programs 108 may make use of or employ a flag variable 118, whereas other test programs 108 may not. It is understood that the above are merely a few illustrative examples to which the disclosed subject matter is not limited.

In various embodiments, the test programs 108 may execute and test the respective hardware components using the respective set of parameters, as described above. In the illustrated embodiment, the activities or operations carried out as a result of the test programs 108 may be measured and monitored. In the illustrated embodiment, the SoC 100 may include a plurality of performance monitors or performance monitoring units (PMUs) 199 distributed throughout the SoC 100. In some embodiments, these PMUs 199 may be included in the processor 101. However, in the illustrated embodiment, one or more of the PMUs 199 may be included by or associated with the various busses or communication channels throughout the SoC 100, and may be external to the processor 101.

In various embodiments, each PMU 199 may be configured to measure and/or memorialize, at least partially, transactions transmitted via the respective busses. In some embodiments, each PMU 199 may include one or more counters or timers. In such an embodiment, detailed information or data regarding the operations carried out by each bus or hardware component may be measured and examined. For example, in one embodiment, using a PMU 199 it may be possible to determine how many times the network interface 160 was read from and/or written to, the frequency or period between such accesses, a number of failed transactions, etc. In various embodiments, each PMU 199 or specific PMUs 199 may be tailored to the specific bus they are coupled with or associated with. In such an embodiment, the PMU 199 may be configured to measure or memorialize specific events. In another embodiment, one or more PMUs 199 may be configurable or dynamically alterable such that different actions or events may be recorded.

In some embodiments, one or more of the test programs 108 may be configured to record their results 119 to the memory 114. In various embodiments, the results 119 may include a simple pass/fail indicator. In another embodiment, the results 119 may include a detailed list of events that were tried or attempted by the test (e.g., 37 writes occurred to the PCIe bus 130, etc.), a list of the results of those events (e.g., 36 successful reads, 1 failed read, etc.), a list of the set of parameters under which the test program 108 was executed or run, etc. In yet another embodiment, the results 119 may include various levels or granularities of details of the test program's 108 operation. It is understood that the above is merely one illustrative example to which the disclosed subject matter is not limited.

Further, in various embodiments, some test programs 108 may record results or provide messages to the mail box 104. In such an embodiment, these message may be returned immediately or in due course to the user via the SCP 102. In another embodiment, some test programs 108 may record results or cause alterations in the counters 197, and/or timers 198. In yet another embodiment, the test programs 108 may return results via a combination of the counters 197, timers 198, PMUs 199, the results 119, and/or the mailbox 104. It is understood that the above are merely a few illustrative examples to which the disclosed subject matter is not limited.

In the illustrated embodiment, the data produced by the execution of the functional test programs 108 may be collected via the SCP 102. In some embodiments, collecting may include executing instructions that cause the SoC 100 or SCP 102 to read from various data collection sources (e.g., the PMUs 199, etc.).

In one embodiment, once the data from a first set of testing programs 108 is collected, the process may be repeated, but with a different set of test programs 108. In some embodiments, the selection of or the parameters used for the second set of test programs 108 may be based, at least in part, upon the results or data collected as a result of the first set of test programs 108. In various embodiments, the cycle of establishing, executing, and then collecting data from various sets of test programs 108 may continue until a threshold number of testing permutations have been executed or targeted.

For example, in one embodiment, the memory channels 150 and 150a may support a finite number of parameter permutations (e.g., frequency, latency, etc.). In such an embodiment, the test programs 108 may be executed until all possible parameter permutations have been targeted or tested. In another embodiment, there may be a threshold number or a limited number of permutations that are being targeted or tested. For example, in one embodiment, the SoC 100 may not be fully compliant with a given standard, and therefore not all permutations of that standard may be tested. It is understood that the above is merely one illustrative example to which the disclosed subject matter is not limited.

In some embodiments, the testing may occur in a hierarchical or recursive fashion. For example in one embodiment, the first set of testing programs 108 may target a plurality of low-level hardware components (e.g., the PCIe-RC 132, the PCIe PHY 134, etc.). In such an embodiment, based at least in part upon the results of the first set of test programs 108, the second set of test programs 108 may target a series of mid-level hardware components (e.g., the PCIe bus 130, etc.). Such a testing scheme may be referred to as a bottom-up testing scheme.

Conversely, a testing scheme may be top-down or recursive. In such an embodiment, a mid-level test program 108 may be configured to target the PCIe bus 130. In such an embodiment, in order to test the PCIe bus 130 the execution of the mid-level test program 108 may launch or cause to be executed a series of low-level test programs 108 that test sub-components of the mid-level hardware component (e.g., the PCIe-RC 132, the PCIe PHY 134, etc.). In various embodiments, a combination of testing schemes may be employed.

In some embodiments, the SoC 100 may include a network control processor (NCP) 103. In such an embodiment, the NCP 103 may be configured to communicate with a network interface (e.g., network interface 160, etc.). In some embodiments, the NCP 103 may be configured to off-load various network management functions from the processor 101 for one or more network interfaces 160. In a specific example, a 10 GbE interface may require too much or an undesirable amount of processing for the processor 101, whereas a wireless (e.g., Bluetooth, etc.) interface may only require a low amount of processing power from the processor 101. In such an embodiment, the management of the 10 GbE interface may be the responsibility of the NCP 103, and the Bluetooth interface may remain the responsibility of the processor 101. It is understood that the above is merely one illustrative example to which the disclosed subject matter is not limited.

In various embodiments, an instance of the STE 106 may be placed on or executed by the NCP 103. In such an embodiment, one or more test programs 108 may be established on the STE 106 of the NCP 103. In such an embodiment, the test program 108 may be configured to test or target portions of the network interface 160 in communication with the NCP 103. In another embodiment, the test program 108 may be configured to target or test the NCP 103 itself (e.g., the NCP's 103 access with the memory 114, etc.). As described above, the data generated by this test program 108 may be collected and evaluated. In various embodiments, the STE 106, test program 108, and the resulting data may all be accessed by the user via the SCP 102, as described above.

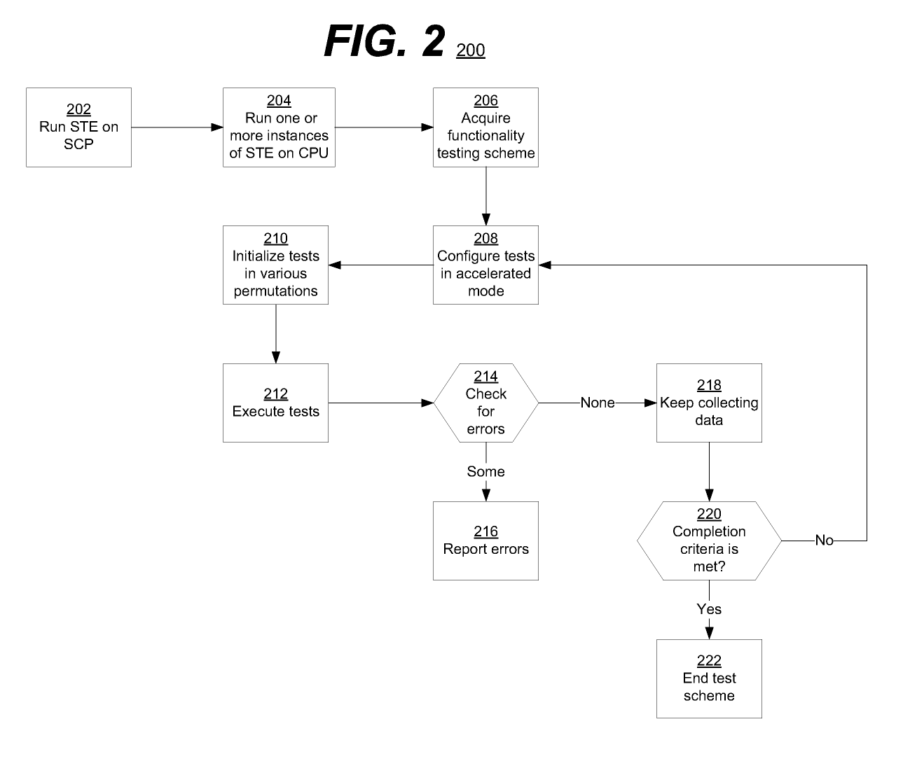

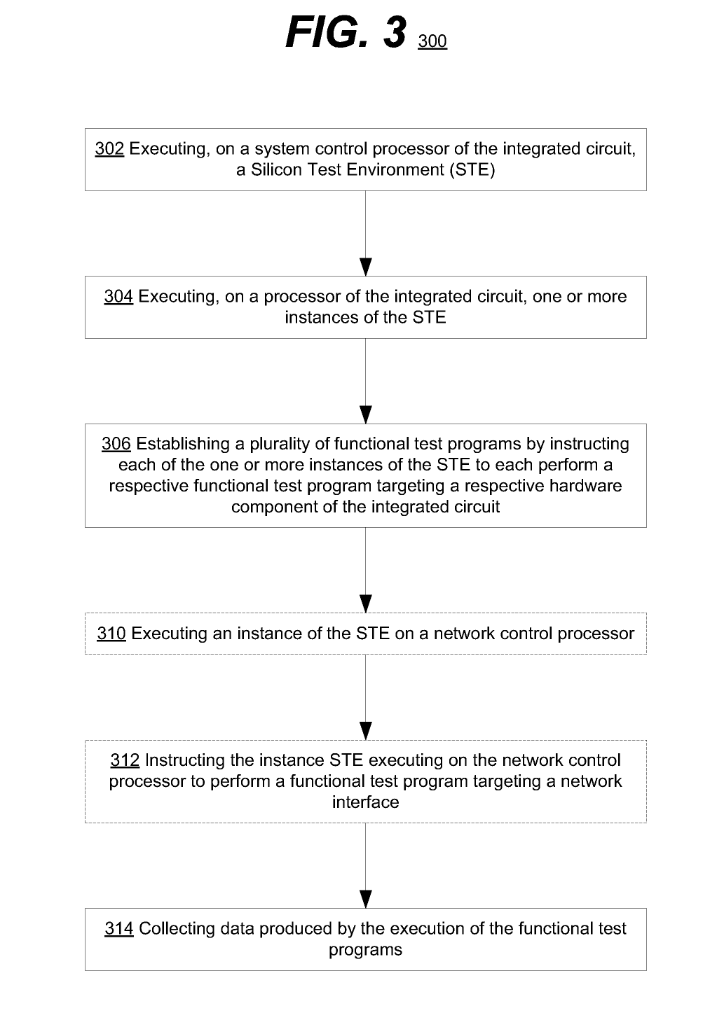

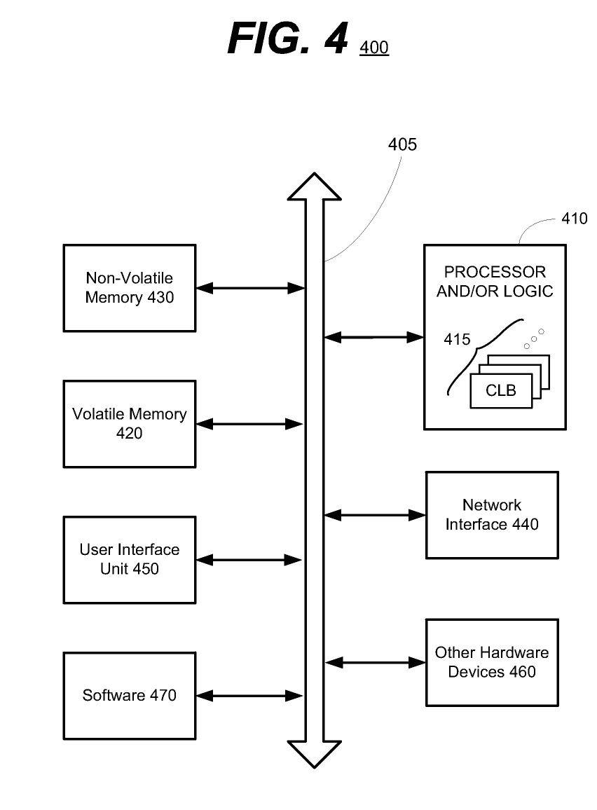

FIG. 2 is a flowchart of an example embodiment of a technique 200 in accordance with the disclosed subject matter. In various embodiments, the technique 200 may be used or produced by the systems such as those of FIG. 1 or 4. Furthermore, portions of technique 200 may be used to in coordination with or as part of other technique such those of FIG. 3. Although, it is understood that the above are merely a few illustrative examples to which the disclosed subject matter is not limited. It is understood that the disclosed subject matter is not limited to the ordering of or number of actions illustrated by technique 200.

Block 202 illustrates that, in one embodiment, an instance of a STE may be run on or executed by a SCP, as described above. In various embodiments, this may allow a central or common interface between the test engineer or user and a large portion of the device under test (DUT). In various embodiments, one or more of the action(s) illustrated by this Block may be performed by the apparatuses or systems of FIG. 1 or 4, the STE 106 of FIG. 1, and/or the SCP 102 of FIG. 1, as described above.

Block 204 illustrates that, in one embodiment, one or more instances of the STE may be run on or executed by the main processor or central processing unit (CPU), as described above. In various embodiments, the main processor may include multiple cores, as described above. In some embodiments, each core may execute multiple instances of the STE, as described above. In various embodiments, one or more of the action(s) illustrated by this Block may be performed by the apparatuses or systems of FIG. 1 or 4, the STE 106 of FIG. 1, and/or the processor 101 and cores 110 of FIG. 1, as described above.

In some embodiments, reliability and longevity testing may also be performed (not explicitly shown in FIG. 2). In such an embodiment, the DUT may be tested to assure or confirm that it is expected to function during a certain interval of time (e.g., 3 years, etc.). In such an embodiment, statistical models may be employed to predict whether the DUT will experience an “event” within the predefined time. In this context, failure of the DUT is considered an “event”. In one such embodiment, the goal of the reliability testing may be to project or forecast a rate of events for a given population of DUTs or the probability of an event for an individual DUT. In such an embodiment, the techniques illustrated herein may also be employed for reliability testing as well as functional testing or other forms of testing. It is understood that the above are merely a few illustrative examples to which the disclosed subject matter is not limited.

Block 206 illustrates that, in one embodiment, a functionally testing scheme may be acquired, as described above. In one embodiment, this scheme may dictate what functional test programs are to be executed by the STE instances running on the processor, as described above.

Block 208 illustrates that, in one embodiment, the functional test programs or tests may be configured in an accelerated mode. In such an embodiment, the accelerated mode may include configuring the test programs to run substantially in parallel using multiple instances of the STE, as described above. In various embodiments, the actions of Block 208 may include establishing a one or more functional test programs by instructing each of the one or more instances of the STE to each perform a respective functional test program targeting a respective hardware component of the integrated circuit, as described above. In some embodiments, each core may execute multiple instances of the STE, as described above. In various embodiments, the test programs may be configured or made ready to execute and their execution may be delayed until an execution variable reaches a predetermined value. In such an embodiment, the test programs may execute substantially simultaneously, despite being established or configured in a serial fashion. In various embodiments, one or more of the action(s) illustrated by this Block may be performed by the apparatuses or systems of FIG. 1 or 4, the STE 106 of FIG. 1, and/or the test programs 108 of FIG. 1, as described above.

Block 210 illustrates that, in one embodiment, the test may be initialized in various permutations, as described above. In some embodiments, a hardware component may be tested using one or more settings or parameters (e.g., frequency, bitrate, voltage, etc.). In various embodiments, the test programs may be configured to execute the core test using a series of sets of parameters. In one embodiment, these sets of parameters may be employed one after another in an iterative or serial fashion. In another embodiment, two or more of these sets of parameters may be employed concurrently or in at least a partially parallel fashion. For example, in FIG. 1 the memory 150 and 150a includes two channels and therefore it was possible to test two sets of parameters substantially simultaneously. It is understood that the above is merely one illustrative example to which the disclosed subject matter is not limited. In various embodiments, one or more of the action(s) illustrated by this Block may be performed by the apparatuses or systems of FIG. 1 or 4, the STE 106 of FIG. 1, and/or the test programs 108 of FIG. 1, as described above.

Block 212 illustrates that, in one embodiment, the test programs may be executed, performed, or run, as described above. In various embodiments, the execution of these tests may result in the collection of data. In some embodiments, the data may be collected by variables in memory, performance mounting units, timers, and counters, or a combination thereof, as described above. It is understood that the above is merely one illustrative example to which the disclosed subject matter is not limited. In various embodiments, one or more of the action(s) illustrated by this Block may be performed by the apparatuses or systems of FIG. 1 or 4, the STE 106 of FIG. 1, the processor 101 and/or the counters 197, timers 198, and/or PMUs 199 of FIG. 1, as described above.

Block 214 illustrates that, in one embodiment, it may be determined whether or not any errors occurred during the execution of the test programs. In various embodiments, this check may occur periodically. In another embodiment, the check may occur either when the tests have concluded or when a test involving a certain set of parameters is completed but before the next set of parameters are tested. In yet another embodiment, when a test encounters an error it may cause an asynchronous alert, message, or interrupt to be generated. It is understood that the above are merely a few illustrative examples to which the disclosed subject matter is not limited.

Block 216 illustrates that, in one embodiment, if an error occurs it may be reported. In some embodiments, this reporting may occur via the SCP. It is understood that the above is merely one illustrative example to which the disclosed subject matter is not limited.

Block 218 illustrates that, in one embodiment, if no error has occurred, the tests may continue and data may continue to be collected, as described above. In various embodiments, the data may be collected or memorialized in performance monitoring units, timers, counters, or variables, as described above. In some embodiments, the tests may continue even if an error has occurred. In yet another embodiment, the test may continue until a predetermined threshold number or severity of errors has occurred. It is understood that the above are merely a few illustrative examples to which the disclosed subject matter is not limited. In various embodiments, one or more of the action(s) illustrated by this Block may be performed by the apparatuses or systems of FIG. 1 or 4, the STE 106 of FIG. 1, the processor 101 and/or the counters 197, timers 198, and/or PMUs 199 of FIG. 1, as described above.

Blocks 220 and 222 illustrate that, in one embodiment, the testing may continue until a predefined set of criteria are met. In one embodiment, these criteria may simply be reaching the end of a predefined list of test pattern (e.g., the 0xDEADBEEF, 0xFFFFFFFF, and/or walking ones/zeroes patterns; etc.). In another embodiment, the criteria may include completing a predefined number of permutations of a plurality of parameters, as described above. In yet another embodiment, the criteria may include testing a certain number of hardware components. It is understood that the above is merely one illustrative example to which the disclosed subject matter is not limited. In various embodiments, if the criteria are not met, the testing may continue.

FIG. 3 is a flowchart of an example embodiment of a technique 300 in accordance with the disclosed subject matter. In various embodiments, the technique 300 may be used or produced by the systems such as those of FIG. 1 or 4. Furthermore, portions of technique 200 may be used in coordination with or as part of other techniques, such those of FIG. 3. Although, it is understood that the above are merely a few illustrative examples to which the disclosed subject matter is not limited. It is understood that the disclosed subject matter is not limited to the ordering of or number of actions illustrated by technique 200.

Block 302 illustrates that, in one embodiment, a Silicon Test Environment (STE) may be executed on a system control processor of the integrated circuit, as described above. In some embodiments, the STE is configured to facilitate an interaction of a functional test program with a processor without aid of an operating system, as described above. In various embodiments, one or more of the action(s) illustrated by this Block may be performed by the apparatuses or systems of FIG. 1 or 4, the STE 106 of FIG. 1, the SCP 102 of FIG. 1, as described above.

Block 304 illustrates that, in one embodiment, one or more instances of the STE may be executed on a processor of the integrated circuit, as described above. In some embodiments, executing may include establishing, via the STE executed by the system control processor, respective instances of the STE on at least two cores of the multi-core processor, as described above. In one embodiment, the STE may be configured to facilitate a testing of an atomic function of a respective hardware component by the functional test program, as described above. In various embodiments, one or more of the action(s) illustrated by this Block may be performed by the apparatuses or systems of FIG. 1 or 4, the STE 106 of FIG. 1, the processor 110 of FIG. 1, as described above.

Block 306 illustrates that, in one embodiment, a plurality of functional test programs may be established by instructing each of the one or more instances of the STE to each perform a respective functional test program targeting a respective hardware component of the integrated circuit, as described above. In one embodiment, establishing a plurality of functional test programs may include establishing a first set of functional test programs via the system control processor, collecting data produced by the execution of, at least part of, the first functional test programs, and establishing a second set of subsequent functional test programs, via the system control processor, based, at least in part, upon the data produced by the execution of, at least part of, the first functional test programs, as described above.

In another embodiment, establishing a plurality of functional test programs may include establishing a first set of functional test programs, wherein the first set of functional test programs target a plurality of low-level hardware components, collecting data produced by the execution of, at least part of, the first set of functional test programs, and establishing a second set of subsequent functional test programs, wherein the second set of functional test programs target a plurality of mid-level hardware components that are associated with low-level hardware components, as described above.

In yet another embodiment, establishing a functional test program to target a respective hardware component under a plurality of different combinations of settings, as described above. In such an embodiment, executing the respective functional test programs may include executing the functional test program by recursively executing the functional test program each time to target the respective hardware component with a respective permutation of the different combinations of settings, and ceasing the execution of the functional test program, if a threshold number of permutations of the different combinations of settings have been targeted, as described above.

In various embodiments, establishing a plurality of functional test programs may include targeting a first set of functional test programs to target one or more hardware component included by the processor, and targeting a second set of functional test programs to target one or more hardware component external to the processor, as described above.

In some embodiments, the integrated circuit may include a first instance of a hardware component and a second instance of a hardware component, as described above. In such an embodiment, establishing a plurality of functional test programs may include instructing a first instance of the STE to perform a functional test program targeting the first instance of the hardware component at a first set of test parameters, and instructing a second instance of the STE to perform a functional test program targeting the second instance of the hardware component at a second set of test parameters, as described above. In some such embodiments, the first set of test parameters and second set of test parameters may both include test parameters selected from a group comprising the following: an operational frequency, a bandwidth, a width of a bus, an error correction setting, and/or an electrical voltage, as described above.

In various embodiments, one or more of the action(s) illustrated by this Block may be performed by the apparatuses or systems of FIG. 1 or 4, the STE 106 of FIG. 1, and/or the test programs 108 of FIG. 1, as described above.

Block 310 illustrates that, in one embodiment, the integrated circuit may include a network control processor configured to communicate with a network interface, as described above. In such an embodiment, an instance of the STE may be executed on a network control processor, as described above. In various embodiments, one or more of the action(s) illustrated by this Block may be performed by the apparatuses or systems of FIG. 1 or 4, the STE 106 of FIG. 1, and/or the NCP 103 of FIG. 1, as described above.

Block 312 illustrates that, in one embodiment, the instance of the STE executing on the network control processor may be instructed to perform a functional test program targeting the network interface, as described above. In various embodiments, one or more of the action(s) illustrated by this Block may be performed by the apparatuses or systems of FIG. 1 or 4, the STE 106 of FIG. 1, and/or the NCP 103 and/or the network interface 160 of FIG. 1, as described above.

Block 314 illustrates that, in one embodiment, data produced by the execution of the functional test programs may be collected, as described above. In various embodiments, the integrated circuit may include a plurality of hardware components communicatively coupled with the processor via one or more busses, as described above. In some embodiments, integrated circuit may include a plurality of performance monitors coupled with the one or more busses and configured to record data that memorializes, at least partially, transactions transmitted via the busses, as described above. In various embodiments, collecting data produced by the execution of the functional test programs may include reading the data from at least one of the performance monitors, as described above. In various embodiments, one or more of the action(s) illustrated by this Block may be performed by the apparatuses or systems of FIG. 1 or 4, the STE 106 of FIG. 1, the processor 101 and/or the counters 197, timers 198, and/or PMUs 199 of FIG. 1, as described above.

FIG. 4 is a schematic block diagram of an information processing system 400, which may include semiconductor devices formed according to principles of the disclosed subject matter.

Referring to FIG. 4, an information processing system 400 may include one or more of devices constructed according to the principles of the disclosed subject matter. In another embodiment, the information processing system 400 may employ or execute one or more techniques according to the principles of the disclosed subject matter.

In various embodiments, the information processing system 400 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 400 may be used by a user (not shown).

The information processing system 400 according to the disclosed subject matter may further include a central processing unit (CPU), logic, or processor 410. In some embodiments, the processor 410 may include one or more functional unit blocks (FUBs) or combinational logic blocks (CLBs) 415. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 400 according to the disclosed subject matter may further include a volatile memory 420 (e.g., a Random Access Memory (RAM), etc.). The information processing system 400 according to the disclosed subject matter may further include a non-volatile memory 430 (e.g., a hard drive, an optical memory, a NAND or Flash memory, etc.). In some embodiments, either the volatile memory 420, the non-volatile memory 430, or a combination or portions thereof may be referred to as a “storage medium”. In various embodiments, the volatile memory 420 and/or the non-volatile memory 430 may be configured to store data in a semi-permanent or substantially permanent form.

In various embodiments, the information processing system 400 may include one or more network interfaces 440 configured to allow the information processing system 400 to be part of and communicate via a communications network. Examples of a Wi-Fi protocol may include, but are not limited to, Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to, IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 400 according to the disclosed subject matter may further include a user interface unit 450 (e.g., a display adapter, a haptic interface, a human interface device, etc.). In various embodiments, this user interface unit 450 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 400 may include one or more other devices or hardware components 460 (e.g., a display or monitor, a keyboard, a mouse, a camera, a fingerprint reader, a video processor, etc.). It is understood that the above are merely a few illustrative examples to which the disclosed subject matter is not limited.

The information processing system 400 according to the disclosed subject matter may further include one or more system buses 405. In such an embodiment, the system bus 405 may be configured to communicatively couple the processor 410, the volatile memory 420, the non-volatile memory 430, the network interface 440, the user interface unit 450, and one or more hardware components 460. Data processed by the processor 410 or data inputted from outside of the non-volatile memory 430 may be stored in either the non-volatile memory 430 or the volatile memory 420.

In various embodiments, the information processing system 400 may include or execute one or more software components 470. In some embodiments, the software components 470 may include an operating system (OS) and/or an application. In some embodiments, the OS may be configured to provide one or more services to an application and manage or act as an intermediary between the application and the various hardware components (e.g., the processor 410, a network interface 440, etc.) of the information processing system 400. In such an embodiment, the information processing system 400 may include one or more native applications, which may be installed locally (e.g., within the non-volatile memory 430, etc.) and configured to be executed directly by the processor 410 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 410.

The semiconductor devices described above may be encapsulated using various packaging techniques. For example, semiconductor devices constructed according to principles of the present inventive concepts may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, etc.). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. A method of testing an integrated circuit comprising:
executing, on a system control processor of the integrated circuit, a Silicon Test Environment (STE), wherein the STE is configured to facilitate an interaction of a functional test program with a processor without aid of an operating system;
executing, on a processor of the integrated circuit, one or more instances of the STE;
establishing a plurality of functional test programs by instructing each of the one or more instances of the STE to each perform a respective functional test program targeting a respective hardware component of the integrated circuit; and
collecting data produced by the execution of the functional test programs.

2. The method of claim 1, wherein the integrated circuit includes a first instance of a hardware component and a second instance of a hardware component; and
wherein establishing a plurality of functional test programs includes:
instructing a first instance of the STE to perform a functional test program targeting the first instance of the hardware component at a first set of test parameters, and
instructing a second instance of the STE to perform a functional test program targeting the second instance of the hardware component at a second set of test parameters.

3. The method of claim 2, wherein the first set of test parameters and second set of test parameters both include test parameters selected from a group comprising the following:
an operational frequency,
a bandwidth,
a width of a bus,
an error correction setting, and
an electrical voltage.

4. The method of claim 1, wherein the integrated circuit includes one or more hardware components communicatively coupled with the processor via one or more busses, and
one or more performance monitors coupled with the one or more busses and configured to record data that memorializes, at least partially, transactions transmitted via the busses; and
wherein collecting data produced by the execution of the functional test programs includes reading the data from at least one of the performance monitors.

5. The method of claim 1, wherein the integrated circuit includes a network control processor configured to communicate with a network interface; and
wherein the method of claim 1 further includes:
executing an instance of the STE on a network control processor, and
instructing the instance of the STE executing on the network control processor to perform a functional test program targeting the network interface.

6. The method of claim 1, wherein establishing a plurality of functional test programs includes:
targeting a first set of functional test programs to target one or more hardware component included by the processor, and
targeting a second set of functional test programs to target one or more hardware component external to the processor.

7. The method of claim 1, wherein the STE is configured to facilitate a testing of an atomic function of a respective hardware component by the functional test program.

8. The method of claim 1, wherein executing, on a processor of the integrated circuit, one or more instances of the STE includes:
establishing, via the STE executed by the system control processor, a first instance of the STE on a first core of the processor, and
establishing, via the STE executed by the system control processor, a second instance of the STE on a second core of the processor; and
wherein establishing a plurality of functional test programs includes:
establishing a first set of functional test programs via the system control processor,
collecting data produced by the execution of, at least part of, the first functional test programs, and
establishing a second set of subsequent functional test programs, via the system control processor, based, at least in part, upon the data produced by the execution of, at least part of, the first functional test programs.

9. The method of claim 1, wherein establishing a plurality of functional test programs includes:
establishing a first set of functional test programs, wherein the first set of functional test programs target a plurality of low-level hardware components;
collecting data produced by the execution of, at least part of, the first set of functional test programs; and
establishing a second set of subsequent functional test programs, wherein the second set of functional test programs target a plurality of mid-level hardware components that are associated with low-level hardware components.

10. The method of claim 1, wherein establishing a plurality of functional test programs includes establishing a functional test program to target a respective hardware component under a plurality of different combinations of settings; and
wherein executing the respective functional test programs includes
executing the functional test program by recursively executing the functional test program each time to target the respective hardware component with a respective permutation of the different combinations of settings, and
ceasing the execution of the functional test program, if a threshold number of permutations of the different combinations of settings have been targeted.

11. An apparatus comprising:
a system control processor configured to execute a Silicon Test Environment (STE), wherein the STE is configured to facilitate an interaction of a functional test program with a processor without an aid of an operating system;
the processor configured to:
execute one or more instances of the STE, and
execute, via the one or more instances of the STE, a plurality of functional test programs, wherein each functional test program is configured to target a respective hardware component; and
one or more hardware components configured to be tested by the plurality of functional test programs.

12. The apparatus of claim 11, wherein the apparatus includes a first instance of a hardware component and a second instance of a hardware component; and
wherein the processor is configured to:
execute a first functional test program targeting the first instance of the hardware component at a first set of test parameters, and
execute a second functional test program targeting the second instance of the hardware component at a second set of test parameters.

13. The apparatus of claim 11, wherein the one or more hardware components are communicatively coupled with the processor via one or more busses, and
wherein the apparatus includes a plurality of performance monitoring units coupled with the one or more busses and configured to record data that memorializes, at least partially, transactions transmitted via the busses; and
wherein the system control processor is configured to collect data produced by the execution of the functional test programs by reading the data from at least one of the performance monitoring units.

14. The apparatus of claim 11, wherein the apparatus includes a network control processor configured to:
communicate with a network interface,
execute an instance of the STE, and
execute, via the instance of the STE executed by the network control processor, a functional test program targeting the network interface.

15. The apparatus of claim 11, wherein the STE is configured to facilitate a testing of an atomic function of a respective hardware component by the functional test program.

16. A computer program product, the computer program product being tangibly and non-transitorily embodied on a computer-readable medium and including executable code that, when executed, is configured to cause an apparatus to:
execute, via a system control processor of the apparatus, a Silicon Test Environment (STE), wherein the STE is configured to facilitate an interaction of a functional test program with a processor without an aid of an operating system;
execute, via a processor of the apparatus, one or more instances of the STE;
establish a plurality of functional test programs by instructing each of the one or more instances of the STE to each perform a respective functional test program targeting a respective hardware component of the apparatus; and
collect data produced by the execution of the functional test programs.

17. The computer program product of claim 16, wherein the apparatus includes a first instance of a hardware component and a second instance of a hardware component; and
wherein the executable code that, when executed, is configured to cause the apparatus to:
instruct a first instance of the STE to perform a functional test program targeting the first instance of the hardware component at a first set of test parameters, and
instruct a second instance of the STE to perform a functional test program targeting the second instance of the hardware component at a second set of test parameters.

18. The computer program product of claim 16, wherein the apparatus includes a plurality of hardware components communicatively coupled with the processor via one or more busses, and
a plurality of performance monitors coupled with the one or more busses and configured to record data that memorializes, at least partially, transactions transmitted via the busses; and
wherein the executable code that, when executed, is configured to cause the apparatus to:
read the data from at least one of the performance monitors.

19. The computer program product of claim 16, wherein the executable code that, when executed, is configured to cause the apparatus to:
establish a first set of functional test programs via the system control processor,
collect data produced by the execution of, at least part of, the first functional test programs, and
establish a second set of subsequent functional test programs, via the system control processor, based, at least in part, upon the data produced by the execution of, at least part of, the first functional test programs.

20. The computer program product of claim 16, wherein the executable code that, when executed, is configured to cause the apparatus to:
establish a first set of functional test programs, wherein the first set of functional test programs target a plurality of low-level hardware components;
collect data produced by the execution of, at least part of, the first set of functional test programs; and
establish a second set of subsequent functional test programs, wherein the second set of functional test programs target a plurality of mid-level hardware components that are associated with low-level hardware components.
